(19) United States
(12) Patent Application Publication
(10) Pub. No.: US 2017/0344722 A1
(43) Pub. Date: Nov. 30, 2017

(54) SYSTEM, METHOD AND RECORDING MEDIUM FOR COGNITIVE HEALTH MANAGEMENT

(71) Applicant: International Business Machines Corporation, Armonk, NY (US)

(72) Inventors: Maryam Ashoori, White Plains, NY (US); Benjamin David Briggs, Waterford, NY (US); Lawrence A. Clevenger, Rhinebeck, NY (US); Leigh Anne Hodges Clevenger, Rhinebeck, NY (US); Jonathan Hudson Connell, II, Cortlandt-Manor, NY (US); Michael Rizzolo, Albany, NY (US)

(21) Appl. No.: 15/167,120

(22) Filed: May 27, 2016

(51) Int. Cl. G06F 19/00; G06F 17/30

(52) U.S. Cl. CPC G06F 19/3456; G06F 17/30477; G06F 19/322

(57) ABSTRACT

A cognitive health management method, system, and non-transitory computer readable medium, include analyzing user input data of a first user by comparing the user input data of the first user to medical data in the database, and providing both of: a recommendation to the first user based on the comparison of the user input data of the first user to the medical data of the database, and a result feedback including a conclusion of the analyzing to a result feedback section of the database.

### BACKGROUND

The present invention relates generally to a cognitive health management method, and more particularly, but not by way of limitation, to a system, method, and recording medium for collecting user health data and analyzing the user health data in real-time as compared to a dynamically updated database including medical literature to instantaneously recommend health choices for a user.

Conventional medicine, food, and health interactions involve a person reporting health history and medications, health metrics, eating habits, etc. to a doctor and the doctor using the doctor's medical training and previously-read known literature to provide feedback on the interactions the food, etc. and the medicine has with health risks.

However, the feedback from the doctor has a technical problem in that the feedback is limited to the doctor's knowledge, is not a real-time feedback based on real-time health data of the user (i.e., the user's heart rate could escalate at a different time causing different health risks with a particular medicine of which the doctor is unaware), the doctor may not be aware of each health risk due to newly published literature that the doctor has not learned yet (i.e., the doctor may not have read the latest literature), and the user cannot benefit from real-time feedback to the doctor from other users based on the doctor's recommendation.

### SUMMARY

Thus, the inventors have realized a technical solution to the technical problem to provide significantly more than the conventional technique of doctor/patient interaction by configuring a real-time analysis of the user's health data concurrently with a database having feedback from other analyses of user health data to provide a more relevant, accurate, faster, up-to-date, and a real-time recommendation for health risks associated with a current user condition and medication/food consumed by the user. Also, the inventors have considered the real-time feedback of other user results to the database to improve the functionality of the system such that real-time feedback is provided to the user and real-time feedback is provided to the state of the art (i.e., the literature). Thus, there is a multi-way improvement provided by the invention.

In an exemplary embodiment, the present invention can provide a cognitive health management method including a database, the method including analyzing user input data of a first user by comparing the user input data of the first user to medical data in the database, and providing both of: a recommendation to the first user based on the comparison of the user input data of the first user to the medical data of the database, and a result feedback including a conclusion of the analyzing to a result feedback section of the database.

Further, in another exemplary embodiment, the present invention can provide a non-transitory computer-readable recording medium recording a cognitive health management program, the program causing a computer to perform: analyzing user input data of a first user by comparing the user input data of the first user to medical data in a database, and providing both of: a recommendation to the first user based on the comparison of the user input data of the first user to the medical data of the database, and a result feedback including a conclusion of the analyzing to a result feedback section of the database.

Even further, in another exemplary embodiment, the present invention can provide a cognitive health management computer system, said system including a medical data database, a processor, and a memory, the memory storing instructions to cause the processor to: analyzing user input data of a first user by comparing the user input data of the first user to medical data in a database, and providing both of: a recommendation to the first user based on the comparison of the user input data of the first user to the medical data of the database, and a result feedback including a conclusion of the analyzing to a result feedback section of the database.

There has thus been outlined, rather broadly, an embodiment of the invention in order that the detailed description thereof herein may be better understood, and in order that the present contribution to the art may be better appreciated. There are, of course, additional exemplary embodiments of the invention that will be described below and which will form the subject matter of the claims appended hereto.

It is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The exemplary aspects of the invention will be better understood from the following detailed description of the exemplary embodiments of the invention with reference to the drawings.

FIG. 1 exemplarily shows a high level flow chart for a cognitive health management method 100.

FIG. 2 depicts a cloud computing node according to an embodiment of the present invention.

FIG. 3 depicts a cloud computing environment according to another embodiment of the present invention.

FIG. 4 depicts abstraction model layers according to an embodiment of the present invention.

### DETAILED DESCRIPTION

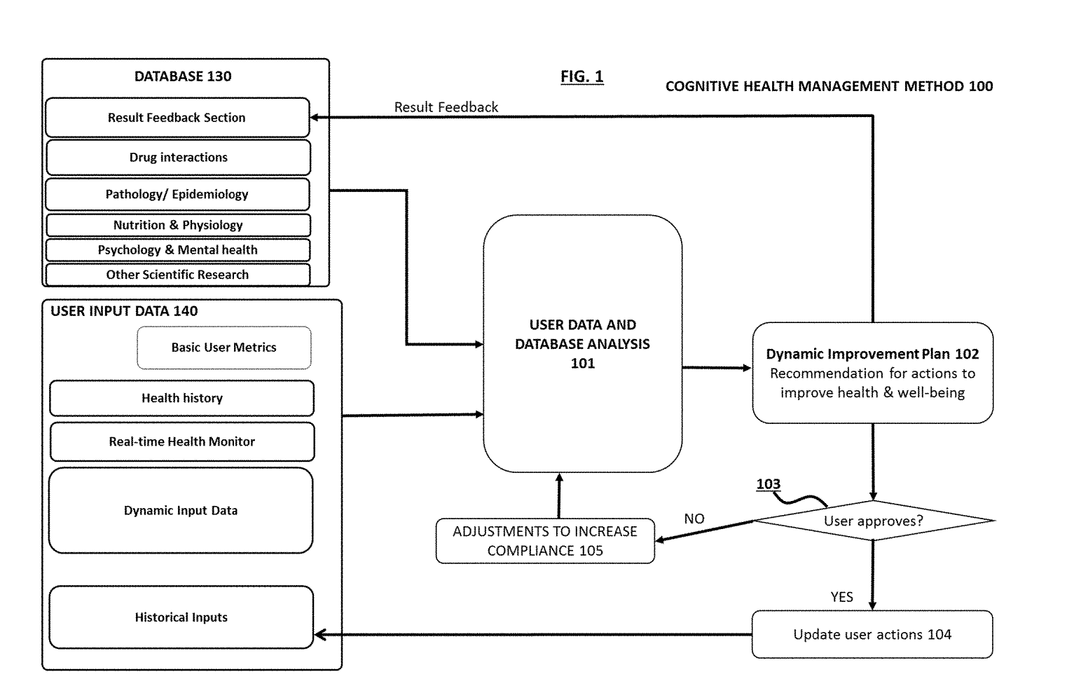

The invention will now be described with reference to FIGS. 1-4, in which like reference numerals refer to like parts throughout. It is emphasized that, according to common practice, the various features of the drawing are not necessarily to scale. On the contrary, the dimensions of the various features can be arbitrarily expanded or reduced for clarity. Exemplary embodiments are provided below for illustration purposes and do not limit the claims.

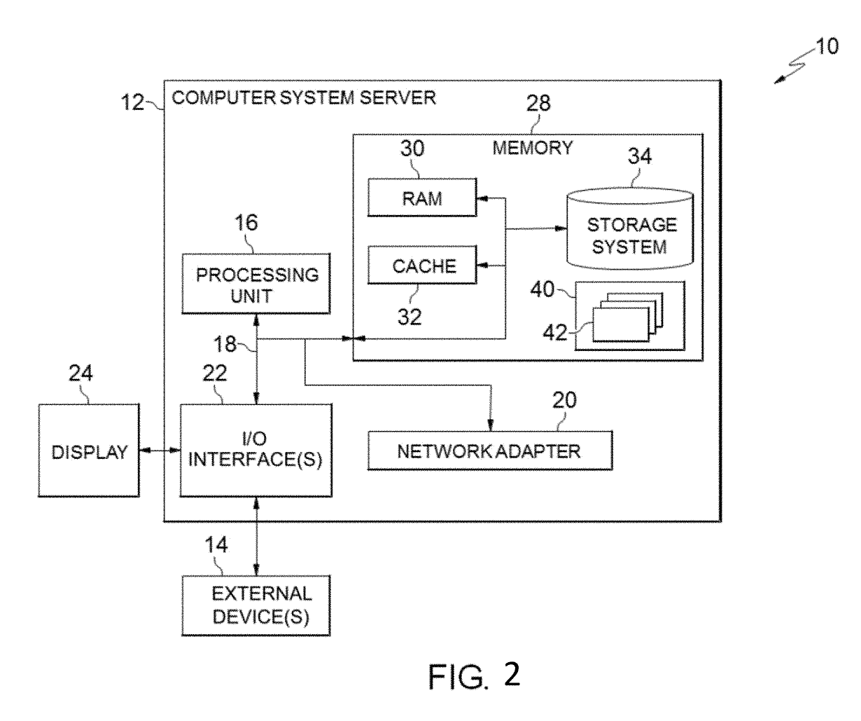

With reference now to FIG. 1, the cognitive health management method 100 includes various steps to provide a user with a real-time recommendation to improve health and well-being and a feedback to a database 130 such that other users can use the real-time recommendation to provide an up-to-date real-time analysis of their conditions. Moreover, the system can benefit from “learning” from past diagnoses. As shown in at least FIG. 2, one or more computers of a computer system 12 can include a memory 28 having instructions stored in a storage system to perform the steps of FIG. 1.

With the use of these various steps and instructions, the cognitive health management method 100 may act in a more sophisticated and useful fashion, and in a cognitive manner while giving the impression of mental abilities and processes related to knowledge, attention, memory, judgment and evaluation, reasoning, and advanced computation. That is, a system is said to be “cognitive” if it possesses macro-scale properties—perception, goal-oriented behavior, learning/memory and action—that characterize systems (i.e., humans) that all agree are cognitive.

Cognitive states are defined as functions of measures of a user's total behavior collected over some period of time from at least one personal information collector (including musculoskeletal gestures, speech gestures, eye movements, internal physiological changes, measured by imaging circuits, microphones, physiological and kinematic sensors in a high dimensional measurement space) within a lower dimensional feature space. In one exemplary embodiment, certain feature extraction techniques are used for identifying certain cognitive and emotional traits. Specifically, the reduction of a set of behavioral measures over some period of time to a set of feature nodes and vectors, corresponding to the behavioral measures' representations in the lower dimensional feature space, is used to identify the emergence of a certain cognitive state(s) over that period of time. One or more exemplary embodiments use certain feature extraction techniques for identifying certain cognitive states. The relationship of one feature node to other similar nodes through edges in a graph corresponds to the temporal order of transitions from one set of measures and the feature nodes and vectors to another. Some connected subgraphs of the feature nodes are herein also defined as a cognitive state. The present application also describes the analysis, categorization, and identification of these cognitive states further feature analysis of subgraphs, including dimensionality reduction of the subgraphs, for example graphical analysis, which extracts topological features and categorizes the resultant subgraph and its associated feature nodes and edges within a subgraph feature space.

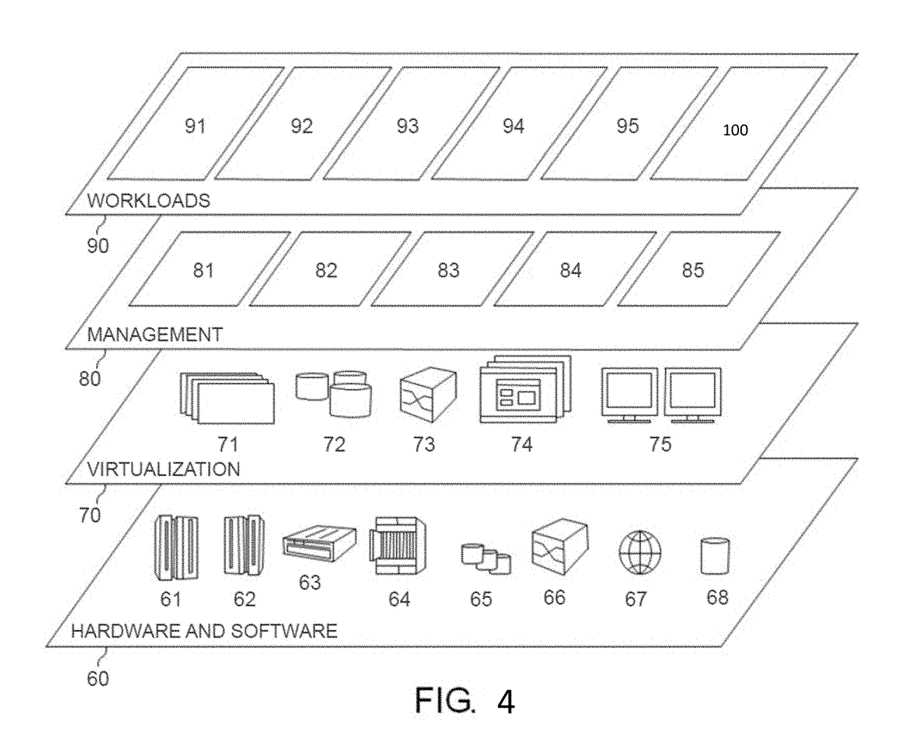

Although as shown in FIGS. 2-4 and as described later, the computer system/server 12 is exemplarily shown in cloud computing node 10 as a general-purpose computing circuit which may execute in a layer the cognitive health management system method (FIG. 4), it is noted that the present invention can be implemented outside of the cloud environment.

Step 101 receives real-time user data from user input data 140 and analyzes and evaluates the real-time user data with medical and nutritional data of the database 130.

The database 130 can include, for example, medical and nutritional literature related to drug interactions (i.e., dosage/response, allergies, side effect triggers, etc.), pathology/epidemiology (i.e., disease detection and prevention data), nutrition and physiology data, psychology and mental health data, other scientific research data, etc. In other words, the database 130 can include all types of medical literature and nutritional data collectively stored such that the user input data 140 can be compared to the data. Also, the database 130 includes a feedback section that receives result feedback from the cognitive health management method 100 such that the database 130 continuously stays up-to-date for each recommended output to assure the patient/user is obtaining in real-time the best diagnosis/recommendation.

The user input data 140 can include, for example, basic user metrics (i.e., age, gender, height, weight, body mass index, etc.), health history of the user (i.e., specific conditions the user has had, past treatments, side effects the user has experienced, etc.), real-time health monitor data (i.e., blood pressure, glucose level, oxygen level, heart rate, etc.), and dynamic input data such as medicine intake, food intake, environment exposure (allergies), activity levels, etc. Further, the user input data 140 can include historical input data such that Step 101 can consider past suggested recommendations and the effectiveness of the recommendations such that the recommendations can be personalized.

Step 102 recommends an action for the user to take based on the analysis of step 201. Step 102 also feeds the recommendation as a result feedback to the feedback section of the database 130. Further, Step 102 recommends the action for the user based on the real-time user input data 140. In this manner, extra precautions can be taken for changes in user conditions to prevent side effects from, for example, a medicine. That is, if the user is experiencing conditions not reported to a doctor, the user input data 140 can feed the real-time conditions to Step 101 such that the medication can be deemed acceptable for the real-time condition of the user.

The recommendation by step 102 can include, for example, an action for the improvement in the health of the user, a warning of a potential side effect, etc. Thereby, the next user that Step 101 receives user data 140 from can have the immediate (i.e., in real-time) benefit of the result feedback of a prior user even if the users are geodetically far away.

Thus, medical, nutritional, and data (both historical and real-time) analyzed in Step 101 can create a recommendation by Step 102 in which the correlations/conclusions simultaneously can be fed back simultaneously to database 130 while personalized recommendations are fed to individual.

That is, Step 102 includes at least two outputs of a feedback to inform the database 130 of the recommendation and a real-time health recommendation to the user.

Step 103 requests approval from the user to follow the recommendation. If the user approves (“YES”), Step 104 updates the historical input section of the user input data 140 with the user accepting the recommendation such that Step 101 can take the user accepting the recommendation into consideration in a future analysis. For example, if the cognitive health management method 100 is analyzing a food menu to recommend a healthy option to a user, if the user accepts the option, Step 102 will attempt to recommend similar options in the future.

If the user does not approve of the recommendation by Step 102 (“NO”), Step 105 makes an adjustment to the recommendation to increase an acceptance chance of the user and Step 101 analyzes if the adjustment is acceptable (i.e., does not trigger health risks).

Thereby, the cognitive health management method 100 can provide personalized recommendations for a user more efficiently and accurately than a doctor as well as create large population collections of recommendations such that future users can benefit from the results. Thus, the database 130 is improved over time.

In a first exemplary embodiment, researchers could be concerned about a side effect of a popular proton-pump inhibitor, and are looking to correlate the effects of the drug on magnesium deficiency and heart attacks in a large-scale population.

Step 101 determines the dosage taken of the user and monitors the real-time side effects, input by the individual or by sensors. Side effects can include low blood pressure, abnormal heart rhythms, muscle spasms, etc. Additional health information for the individual is also collected, including diet, exercise, etc.

Step 102 outputs the results/conclusions of the analysis of the data to the result feedback section of the database 130 such that the researchers can examine the results. Also, Step 102 can recommend a dosage for the individual within a range pre-set by a medical professional if a side effect occurs for the individual.

In a second exemplary embodiment, medical researchers can be looking to correlate the effects of Digoxin® consumption on heart failure in a large scale population.

A first user has user input data to step 101 that shows that the user is a cardiac patient that takes Digoxin® for heart failure (as included in the user input data 140). Digoxin® strengthens the contraction of heart muscles and slows the heart rate. Also, the user input data 140 indicates that it is in the morning and the user has to decide what to have for breakfast. The user's blood pressure is higher than what is expected. Further, the user input data 140 includes the history of the user's eating habits which show a considerable consumption of ginseng and salty food.

Step 101 receives the user input 140 and analysis the above conditions and determines from the medical information of the database 130 that ginseng can elevate blood levels of Digoxin® by as much as 75%. Further, step 101 concludes that a banana brings down the blood pressure and it is high in potassium, which is a good supplement for Digoxin® and that grapefruit juice may modestly increase the plasma concentrations of Digoxin® and has to be avoided. Step 101 analysis concludes that patients on digoxin have to maintain a regular diet without significant fluctuation in fiber intake and limited consumption of herbs and salt substitutes.

Step 102 outputs the recommendation of eating a banana to the user as well as the detrimental effects of having grapefruit juice. Similarly, the results are fed back to the database 130 such that the researchers can utilize the up-to-date and real-time results.

In a third exemplary embodiment, the user input data 140 to Step 101 indicates that it is dinner time and the user is currently viewing a menu to decide on which meal to order. Also, it is noted that the blood pressure is unusually high for the user.

Step 101 can retrieve the menu from the user and analyze the menu with the data of the database 130 to provide a healthiest option based on the user's real-time data.

Therefore, Step 102 can recommend pomegranate, salmon, with a side of whole grain pasta which would help to bring down the user's blood pressure and also does not interact with his medications. The recommendation can also be fed back to the result feedback section of the database 130 such that another user at that restaurant can be suggested the same meal if they have similar user input data 140.

### Exemplary Hardware Aspects, Using a Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

As shown in FIG. 2, computer system/server 12 in cloud computing node 10 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

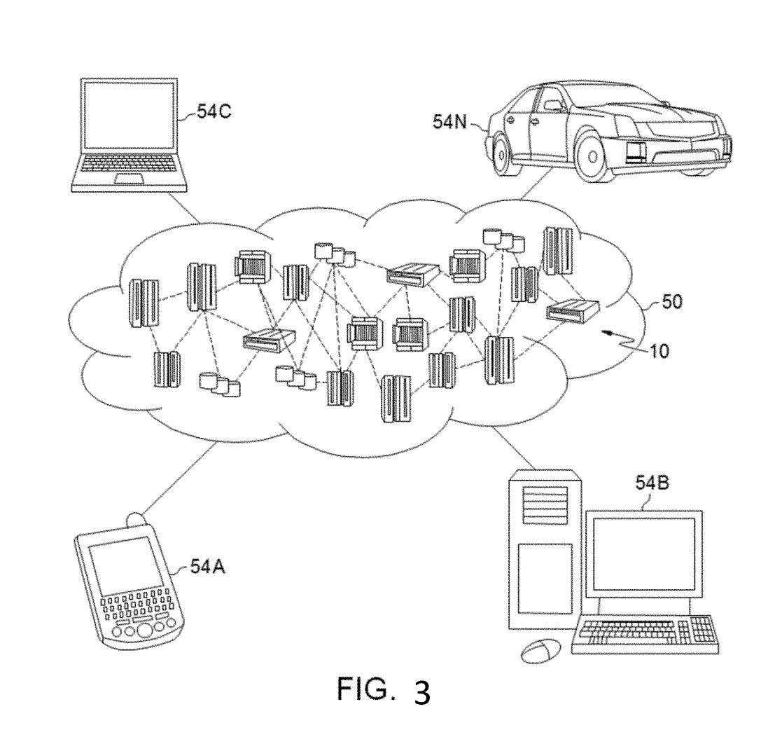

Referring now to FIG. 3, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 11 are intended to be illustrative only and that computing nodes 10 and cloud computing environment 50 can communicate with any type of computerized circuit over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the anti-counterfeiting system 100 and the anti-counterfeiting system 600 described herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A cognitive health management method including a database, the method comprising:
analyzing user input data of a first user by comparing the user input data of the first user to medical data in the database; and
providing both of:
a recommendation to the first user based on the comparison of the user input data of the first user to the medical data of the database; and
a result feedback including a conclusion of the analyzing to a result feedback section of the database.

2. The method of claim 1, wherein the analyzing analyzes the user input data in real-time.

3. The method of claim 1, wherein the providing provides the result feedback to the result feedback section of the database such that the analyzing compares user input data of a second user to updated medical data in the database including the result feedback of the result feedback section.

4. The method of claim 1, wherein the user input data includes a schedule for taking medication, and
wherein the analyzing compares a time of day against the schedule for taking the medication such that the providing provides an optimal time of day to take the medication.

5. The method of claim 1, wherein the medical data in the database includes at least one of:
a list of drug interactions;
pathology data;
epidemiology data;
nutrition data;
physiology data;
psychology data;
mental health data; and
historical scientific data.

6. The method of claim 5, wherein the result feedback section of the database updates corresponding data to the result feedback in the database.

7. The method of claim 1, wherein the result feedback is provided by the providing to the result feedback section of the database such that the database is up-to-date with a latest recommendation.

8. The method of claim 1, wherein the result feedback is provided by the providing to the result feedback section of the database such that the database is up-to-date with a latest recommendation for user input data of a second user with which to be compared.

9. The method of claim 1, further comprising:
querying the first user to approve the recommendation;
updating the user input data of the first user based on the first user approving the recommendation; and
analyzing an adjustment made to the recommendation to the first user when the first user denies the recommendation so as to provide a second recommendation based on a second comparison of the adjustment made to the recommendation, the user input data of the first user, and the medical data of the database.

10. The method of claim 1, wherein the user input data includes a list of food choices, and
wherein the analyzing compares each food choice of the list of food choice with the user input data of the first user and the medical data of the database such that the providing provides at least one of the food choices as a food recommendation.

11. The method of claim 1, wherein the analyzing analyzes the user input data of the first user, a recipe for a meal provided in the database, and the medical data of the database such that the providing provides an optimal recipe for the first user to reduce health risk.

12. The method of claim 1, wherein the user input data includes at least one of:
a basic user metric;
health history data;
a real-time output of health conditions;
a real-time status of food intake;
a list of medications;
a current environment; and
a historical list of the recommendation provided by the providing.

13. The method of claim 1, wherein the user input data is in real-time and the medical data of the database is dynamically updated based on the providing providing a recommendation to a second user such that the analyzing compares the real-time user input data of the first user to a most recent version of the medical data of the database.

14. A non-transitory computer-readable recording medium recording a cognitive health management program, the program causing a computer to perform:
analyzing user input data of a first user by comparing the user input data of the first user to medical data in a database; and
providing both of:
a recommendation to the first user based on the comparison of the user input data of the first user to the medical data of the database; and
a result feedback including a conclusion of the analyzing to a result feedback section of the database.

15. A cognitive health management system, said system comprising:
a medical data database;
a processor; and
a memory, the memory storing instructions to cause the processor to:
analyze user input data of a first user by comparing the user input data of the first user to medical data in a database; and
provide both of:
a recommendation to the first user based on the comparison of the user input data of the first user to the medical data of the database; and
a result feedback including a conclusion of the analyzing to a result feedback section of the database.

16. The system of claim 15, wherein the analyzing analyzes the user input data in real-time.

17. The system of claim 15, wherein the providing provides the result feedback to the result feedback section of the database such that the analyzing compares user input data of a second user to updated medical data in the database including the result feedback of the result feedback section.

18. The system of claim 15, wherein the user input data includes a schedule for taking medication, and
wherein the analyzing compares a time of day against the schedule for taking the medication such that the providing provides an optimal time of day to take the medication.

19. The system of claim 15, wherein the result feedback is provided by the providing to the result feedback section of the database such that the database is up-to-date with a latest recommendation.

20. The system of claim 15, wherein the result feedback is provided by the providing to the result feedback section of the database such that the database is up-to-date with a latest recommendation for user input data of a second user with which to be compared.
